(19) United States
(12) Patent Application Publication
(10) Pub. No.: US 2026/0236621 A1
(43) Pub. Date: Aug. 13, 2026

(54) PROCESSING SYSTEM PROVIDED WITH A FREEDOM FROM INTERFERENCE MECHANISM

(71) Applicant: Renesas Electronics Corporation, Tokyo (JP)

(72) Inventors: Stefan GELDREICH, Dusseldorf (DE); Shijia GUO, Troy, MI (US); Heinz Michael FRESE, Kaarst (DE); Xavier Julien Jean TOUATI, Rueil Malmaison (FR)

(73) Assignee: Renesas Electronics Corporation, Tokyo (JP)

(21) Appl. No.: 19/050,543

(22) Filed: Feb. 11, 2025

(51) Int. Cl. G06F 21/73; G06F 13/42

(52) U.S. Cl. CPC G06F 21/73; G06F 13/4282

(57) ABSTRACT

A processing system is provided with a freedom from interference mechanism. The processing system includes a plurality of master components, a plurality slave components; a bus; and a plurality of slave registers. The processing system assigns a master identification to each master component. Each slave register stores a list of permissible master identifications that allow access to a corresponding slave component. Each slave component has a protection circuit configured to permit or prevent access to the slave component based on the master identification of the master component attempting access.

### TECHNICAL FIELD

The present disclosure relates to a processing system spatially partitioned in a plurality of domains for specific applications or functions. In particular, the present disclosure relates to a processing system provided with freedom from interference mechanism or functionality.

### BACKGROUND

System architectures are evolving to support multiple applications. For instance, in the automotive industry a system architecture often needs to support multiple applications with mixed Automotive Safety Integrity Level (ASIL) on a single system on chip (SoC). This requires to spatially partition the SoC to support the mixed ASIL applications and ensure freedom from interference.

Freedom from Interference (FFI) is a term defined in the ISO 26262 standard that refers to the absence of cascading failures between hardware and software components. Three types of interference are specified: timing and execution, memory, and exchange of information.

Current spatial FFI solutions are limited when supporting spatially partitioning a SoC system with multiple masters. Software based methods such as the use of a hypervisor (HV) cannot guarantee full freedom from interference. It is an object of the disclosure to address one or more of the above mentioned limitations.

### SUMMARY

According to a first aspect of the disclosure, there is provided a processing system comprising a plurality of master components, wherein the processing system is configured to assign a master identification to each master component; a plurality slave components; a bus for communication between the plurality of master components and the plurality of slave components; a plurality of slave registers, each slave register being configured to store a list of permissible master identifications that allow access to a corresponding slave component; wherein each slave component has a protection circuit configured to permit or prevent access to the slave component based on the master identification of the master component attempting access.

For instance, a master component may be a processor such as an application processor. A slave component may be a memory. Alternatively, or in combination a slave memory may include programmable input/output/advanced peripherals.

Optionally, for each slave component the protection circuit is configured to compare a master identification with the list of permissible master identifications for the slave component, and to grant access only when the master identification matches a permissible master identification.

Optionally, wherein access to a slave component is restricted to one or more specific task.

For instance, access may be restricted to a reading task or a writing task.

Optionally, the master identification comprises a number.

For instance the master identification may be an integer (0, 1, 2, 3. . . )

Optionally, each slave register is configured to store a binary sequence of zeros and ones for each task to be performed on the slave component and wherein each number (0 or 1) in the binary sequence is associated with a specific master identification.

For instance a binary sequence may be 0001 for a specific task, for example a reading task. The numeral 1 may represent that the task is permitted and the numeral 0 that the task is not permitted.

Optionally, the processing system comprises one or more master registers, each master register being configured to store a master identification for a corresponding master component.

Optionally, the processing system comprises a configuration circuit adapted to configure the plurality of master registers and slave registers.

For instance the configuration circuit may be a safety core.

Optionally, each master component comprises at least one of a master register, a memory management unit and an input-output memory management unit.

Optionally, each master register is configured to store a master identification for a corresponding master component.

Optionally, wherein the memory management unit and the system memory management unit, each comprise a translation table, and wherein the master identification is encoded in the translation table.

Optionally, the translation table is configured by an operating system or by a user software.

Optionally, the processing system further comprises a verification circuit configured to compare the master identification with a list of permitted values; and wherein when identifying that the master identification is different from a permitted value the verification circuit if configured to change the master identification to a predefined error value or to block propagation of the master identification.

Optionally, wherein when the protection circuit receives a master identification having the predefined error value, the protection circuit is configured to block access to a slave component.

For instance, the predefined error value may be any value outside of the list of allowable values.

Optionally, wherein the processing system is spatially partitioned in a plurality of domains, wherein for each domain at least one master component and at least one slave component are assigned to a specific application or function.

Optionally, wherein master components serving one application or function cannot access the slave components serving another application or function.

Optionally, wherein each domain has a different characteristic. For instance, the characteristic may be a level of safety requirements and/or a software vendor.

For instance, different domains may have different levels of safety requirements. For example different ASIL levels.

Optionally, at least one master component comprises a plurality of sub parts, and wherein the processing system is configured to assign a master identification to each sub part of the master component.

For instance, the plurality of sub parts may be a plurality of channels or a plurality of operating instances within a cluster, and the processing system is configured to assign a master identification to each channel or to each operating instance. An operating instance may be a CPU having its own operating system.

Optionally, wherein the processing system is implemented as an integrated electronic system. For instance, the integrated electronic system may be a system on chip (SoC) or a microcontroller (MCU).

According to a second aspect of the disclosure, there is provided a method of preventing interference in a processing system comprising a plurality of master components and a plurality of slave components, the method comprising
assigning a master identification to a corresponding master component;
storing a list of permissible master identifications that allow access to a corresponding slave component;
permitting or preventing a master component to access a slave component based on the master identification of the master component.

For instance different types of interference may be prevented including execution interference and memory interference.

Optionally, the step of permitting or preventing access to a slave component comprises comparing a master identification with a list of permissible master identifications for the slave component, and only permitting access when identifying a match between a master identification and a permissible master identification.

### DESCRIPTION OF THE DRAWINGS

The disclosure is described in further detail below by way of example and with reference to the accompanying drawings, in which:

FIG. 1 is a diagram illustrating a risk of interference in a multi-core multi-applications processing system;

FIG. 2 is a diagram of an exemplary processing system with multiple masters;

FIG. 3 is a diagram of a freedom from interference (FFI) mechanism based on a memory protection unit (MPU);

FIGS. 4A and 4B are diagrams of an FFI mechanism based on memory management unit (MMU) or input-output memory management unit (IOMMU);

FIGS. 5A-5C are diagrams illustrating the limitations of current FFI mechanisms based on MMU or IOMMU;

FIG. 6 is a flow chart of method for preventing interference in a processing system comprising a plurality of master components and a plurality of slave components;

FIG. 7 is a diagram of a processing system for implementing the method of FIG. 6;

FIG. 8 is a diagram of another processing system for implementing the method of FIG. 6;

FIG. 9 is a diagram of an example implementation of a region ID MPU;

FIG. 10 is a diagram of a system having a lower Automotive Safety Integrity Level (ASIL) partition, a higher ASIL partition and a lower ASIL OS/HV;

FIG. 11 is a diagram of another system partitioned between lower ASIL and higher ASIL;

FIG. 12 is a diagram of a system having a lower ASIL partition and a higher ASIL partition;

FIG. 13 a diagram of a processing system comprising different types of master components.

### DESCRIPTION

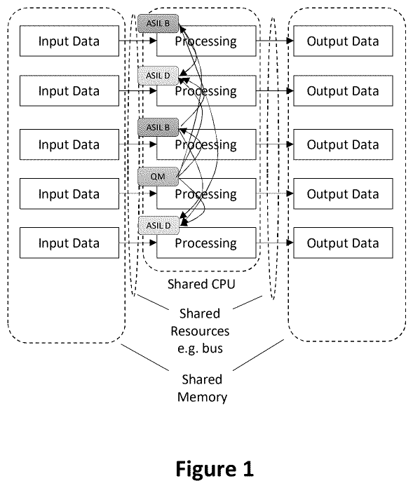

FIG. 1 is a diagram illustrating a use case which present a risk of interference in a multi-core multi-applications processing system. Automotive Safety Integrity Level (ASIL) is a risk classification scheme defined by the ISO 26262. There are four ASILs ranked with letters A, B, C and D in which ASIL A has the lowest integrity requirements and ASIL D has the highest integrity requirements. Hazards that are identified as “quality managed” QM do not dictate any safety requirements.

In many real world applications, the different processes may interact with each other as shown in FIG. 1. This increases the risk of data and/or processing interferences. Such interferences may include timing and execution (i.e blocking, incorrect allocation, incorrect sync), memory (data corruption, inconsistent data), and exchange of information (repetition, loss, delay, corruption etc . . . ).

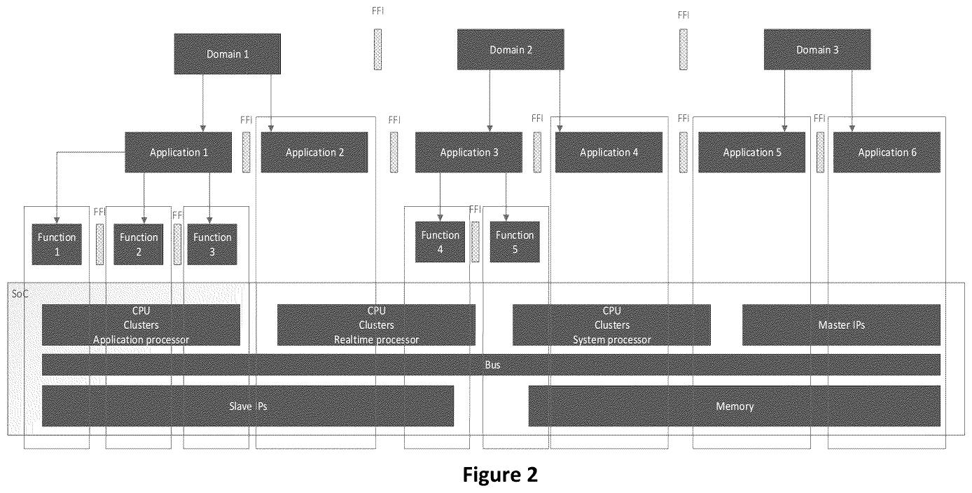

FIG. 2 is a diagram of an exemplary processing system with multiple masters. In this example a SoC hosts multiple applications from several logical domains labelled domain 1, 2 and 3. In an exemplary implementation for the automotive industry the domains 1, 2 and 3 may be autonomous driving (AD), In-vehicle infotainment (IVI) and Vehicle computing processor (VCP), respectively.

The first domain (for example AD domain) has two applications. For example the first application may be front camera and the second application surround view camera. The second domain (for example IVI domain) has two applications. For example cluster and infotainment. The third domain (for example VCP domain) has two applications, for example controller area network (CAN) routing and over-the-air update (OTA). All applications 1-6 and logical domains 1-3 must be isolated from each other. In the first application, there are three functions, for instance path one path two and fusion. In the third application, there are two functions, for instance telltale and electronic dashboard. All functions must also be isolated from each other.

The SoC is spatially partitioned, and each partition serves a function or application. Stated another way the spatial partition permits to assign certain masters and slaves/memory to serve one application or function, and to assign other masters and slaves/memory to serve another application.

To ensure that applications or functions do not interfere with each other spatially, the masters serving one application or function should not interfere or access the slaves/memory serving another application or function. This is called spatial freedom from interference (FFI). As shown in FIG. 2, FFI should be provided between domains, between applications and between functions.

The spatial FFI protection of the system may be implemented using a memory protection unit (MPU) or a memory management unit (MMU) or an input-output memory management unit (IOMMU). An MPU is a computer hardware unit that provides memory protection. It can be implemented using low power processors that require only memory protection. A memory management unit (MMU) is a computer hardware unit configured to examine memory references on the memory bus, and to translate virtual memory addresses into physical addresses in the memory. An input-output memory management unit (IOMMU) is a memory management unit (MMU) connecting a direct-memory-access-capable (DMA-capable) I/O bus to the memory.

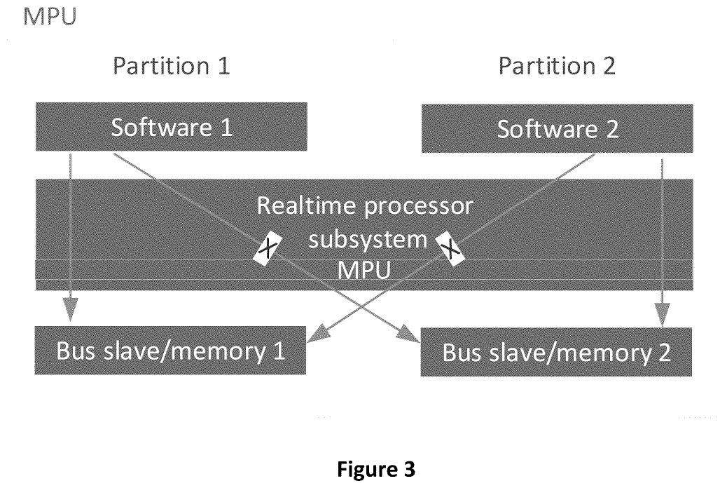

FIG. 3 is a diagram of an FFI mechanism based on MPU. The MPU is configured for each software among software 1 and software 2 (for instance the software 1 and 2 may be implemented as virtual machines (VMs) or process in Portable Operating System Interface (POSIX) term, OS application in Autosar term). The software 1 is allowed to access only the Bus slave/memory 1 address range, and not the Bus slave/memory 2 address range. Similarly, the software 2 is allowed to access only the Bus slave/memory 2 address range, and not the Bus slave/memory 1 address range.

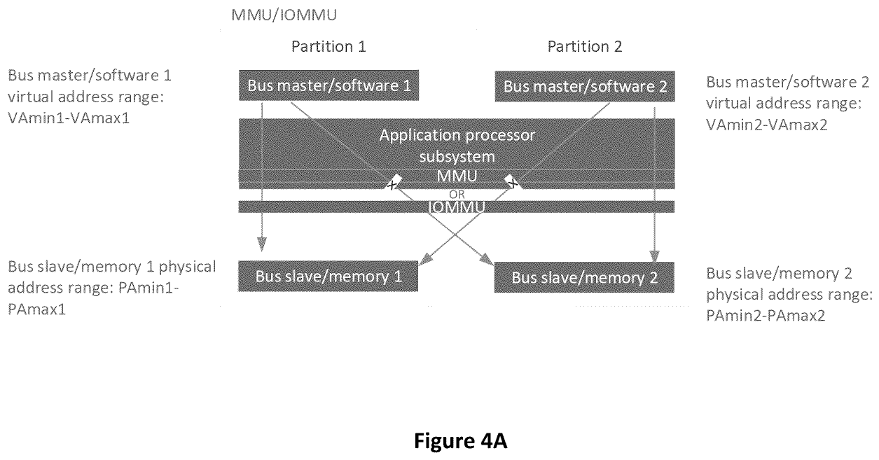

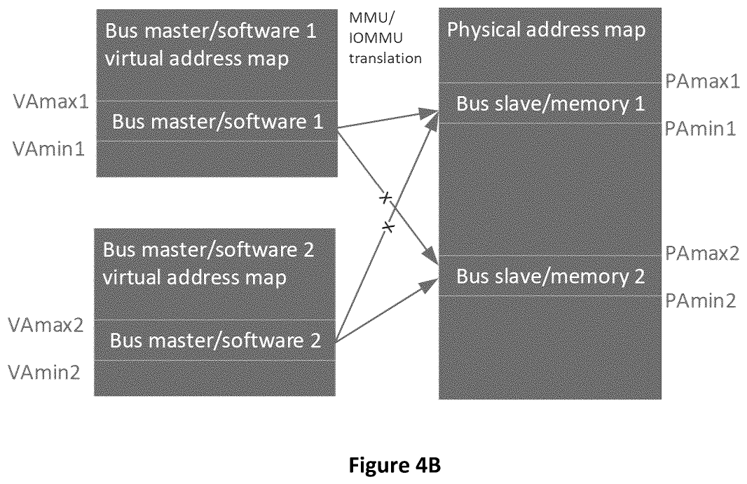

FIGS. 4A and 4B are diagrams of an FFI mechanism based on MMU or IOMMU. User configures MMU/IOMMU to set bus master or software (“process” in POSIX term) to bus slave/memory access.

The MMU hardware and MMU translation tables are usually configured and prepared by the operating system. Some operating system use user/group to control access. A Bus slave/memory (device) allow access from certain groups. A group contains users, users spawn processes-the access is associated from process to devices. The IOMMU hardware and IOMMU translation table are usually configured and prepared by the user or user software. The MMU or IOMMU may be used to translate virtual addresses (VA) to physical addresses (PA).

Access is controlled for each bus master/software (process in POSIX term) vs bus slave/memory pair by the MMU. Only bus master/software 1 VA to Bus slave/memory 1 PA translation is prepared because access is allowed: bus master/software 1 VA can be translated to Bus slave/memory 1 PA, bus master/software 1 VA can access Bus slave/memory 1 PA.

Bus master/software 1 VA to Bus slave/memory 2 PA translation is not prepared because access is not allowed: bus master/software 1 VA cannot be translated to Bus slave/memory 1 PA, bus master/software 1 VA cannot access Bus slave/memory 1 PA.

Only bus master/software 2 VA to Bus slave/memory 2 PA translation is prepared because access is allowed: bus master/software 2 VA can be translated to Bus slave/memory 2 PA, bus master/software 2 VA can access Bus slave/memory 2 PA.

Bus master/software 2 VA to Bus slave/memory 1 PA translation is not prepared because access is not allowed: bus master/software 2 VA cannot be translated to Bus slave/memory 2 PA, bus master/software 2 VA cannot access Bus slave/memory 2 PA.

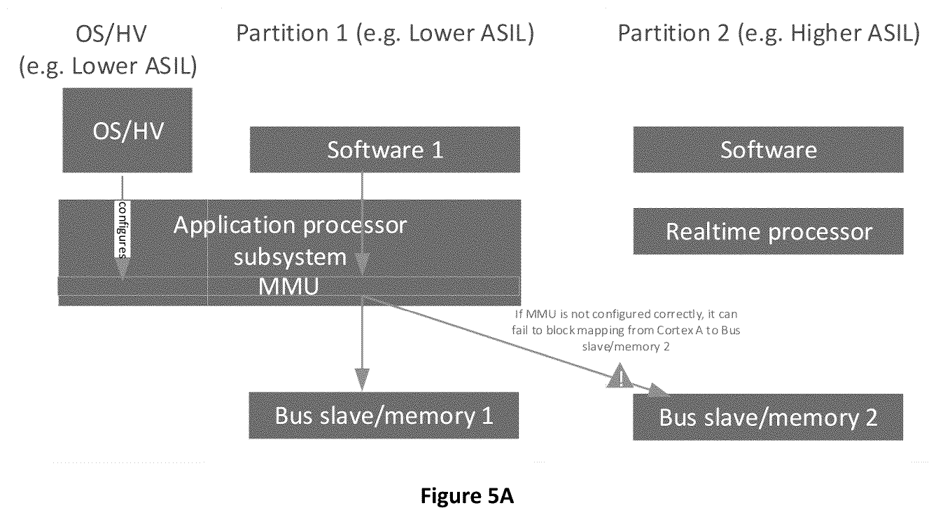

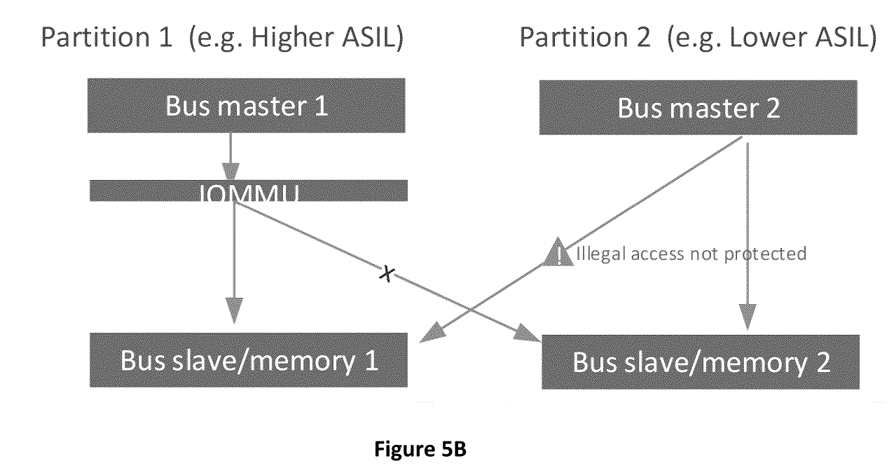

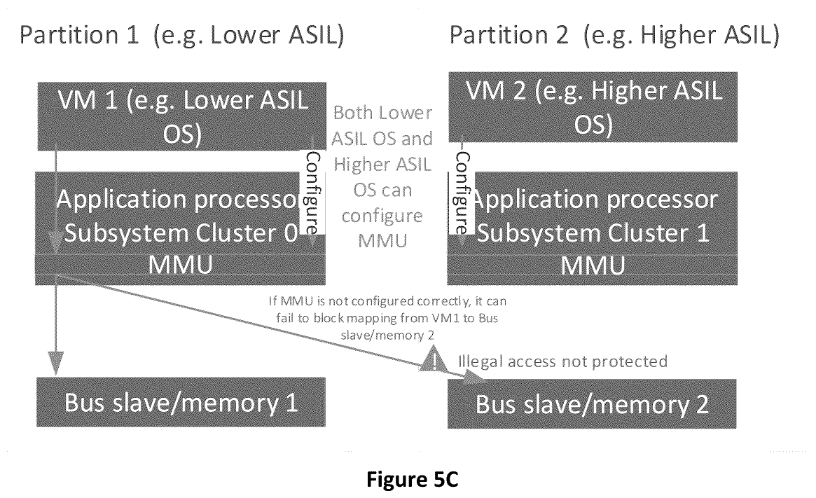

FIGS. 5A-5D are diagrams illustrating the limitations of current FFI mechanisms based on MMU or IOMMU.

In FIG. 5A the application processor subsystem must use the highest ASIL operating system (OS) with relation to applications considered on this SoC, or hypervisor (HV). If not, the lower ASIL OS or HV can configure the MMU in the wrong way to access other higher ASIL areas.

In FIG. 5B, if bus master 1 is connected to IOMMU, IOMMU can allow mapping from bus master 1 to bus slave/memory 1 and not allow mapping from bus master 1 to bus slave/memory 2. But if the bus master 2 is not connected to the IOMMU, then mapping from bus master 2 to both bus slave/memory 2 and bus slave/memory 1 are allowed. Therefore, the bus slave/memory 1 may be corrupted by bus master 2.

In FIG. 5C, the Lower ASIL OS can set the MMU in the wrong way and accesses higher ASIL area. In such instances illegal access is not protected.

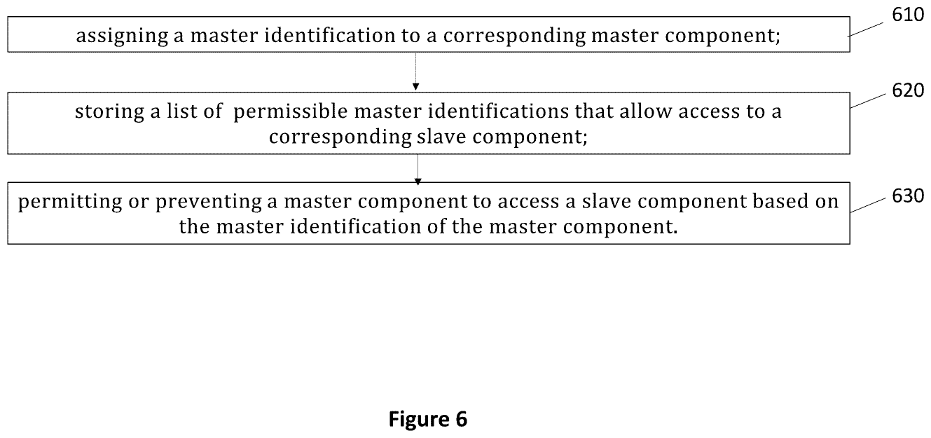

FIG. 6 is a flow chart of a method for preventing interference in a processing system comprising a plurality of master components and a plurality of slave components.

At step 610 a master identification is assigned to a corresponding master component. The master identification, also referred to as region ID (RGID) may be a number that is uniquely assigned to each master. The region ID may be assigned to each master at start-up. This may be achieved via a master register. Depending on the implementation of the master component, the master component may be assigned more than one master identification (RGID).

At step 620 a list of permissible master identifications permitting access to a corresponding slave component is stored. At step 630 a master component is either permitted to access (or prevented from accessing) a slave component based on the master identification of the master component.

Using this approach prevents the occurrence of interference in a processing system spatially partitioned in a plurality of domains for specific applications or functions. In particular, this method prevents memory interference and spatial interference.

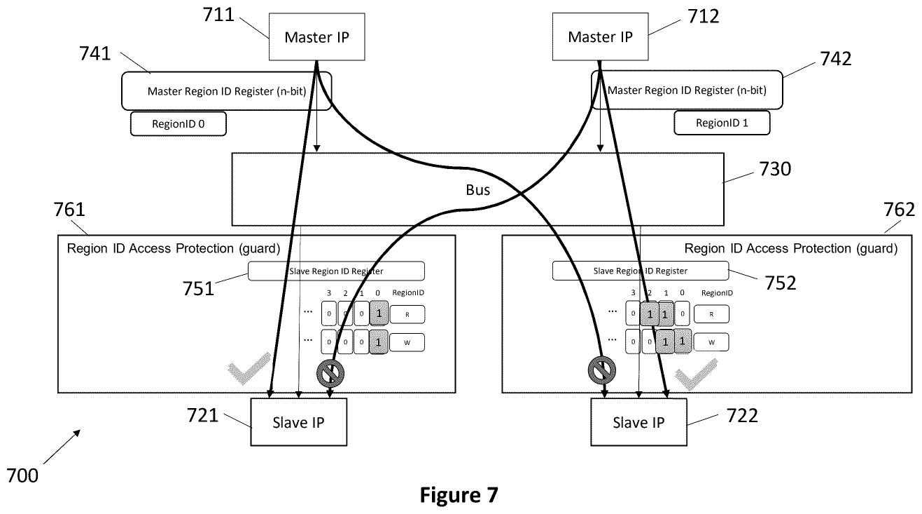

FIG. 7 is a diagram of a processing system for implementing the method of FIG. 6. The processing system 700 includes a plurality of master components and a plurality of slave components communicating via a bus. In this example the system includes two master components 711, 712, two slave components 721, 722 and one bus 730. A master component may be a processor such a core or a central processing unit (CPU). Examples of a CPUs include application processor, realtime processor, system processor, among others. Each master has a several functionalities. These functionalities have Intellectual Property or “master IP”. A slave component may be a circuit or a memory. A slave memory may include programmable input/output/advanced peripherals. A slave may also have functionalities, these functionalities have Intellectual Property or “slave IP”.

The system also includes a plurality of master registers and a plurality of slave registers. The master component 711 has the master register 741, and master component 712 has the master register 742. Similarly, the slave component 721 has the slave register 751, and the slave component 722 has the slave register 752.

Each master register assigns a master identification, also referred to as master region ID (RGID) to a corresponding master component. Each slave register stores a list of permissible master identifications (region IDs) permitting access to a corresponding slave component.

Each slave component is provided with a protection circuit, also referred to as access guard, or simply guard. In FIG. 7 two guards are provided 761, 762 for the slaves 721 and 722, respectively. Each guard is configured to permit or prevent a master component to access a slave component based on the master identification (region ID) of the master component.

In operation, the master 711 is assigned the RGID 0 and the master 712 is assigned RGID 1. The protection circuit then receives a plurality of a master identifications (region IDs), compares the master identifications (region IDs) with the list of permissible master identifications (region IDs) for the slave component, and grant access only when the master identification matches a permissible master identification. FIG. 7 illustrates a specific example with the masters 711 and 712 each trying to access the slaves 721 and 722 to perform various actions, in this case read (R) or write (W) on the slave. Permission can be given separately for read and write access.

If the master 711 tries to access the slave 721, the guard 761 receives region ID “0” and compares it with the slave register information for region 0. For the RGID 0, a numeral “1” is provided for both read R and write W functionalities, indicating that both R&W are allowed. Therefore the master 711 can perform both R&W on the slave 721.

If the master 712 tries to access the slave 721, the guard 761 receives region ID “1” and compares it with the slave register information for region 1. For the RGID 1, a numeral “0” is provided for both read R and write W functionalities, indicating that both R&W are not allowed. Therefore, the master 712 cannot perform either R&W on the slave 721.

If the master 711 tries to access the slave 722, the guard 762 receives region ID “0” and compares it with the slave register information for region 0. For the RGID 0, a numeral “0” is provided for read R and a numeral “1” is provided for write W. Therefore the master 711 can write on the slave 722 but cannot read on 722.

If the master 712 tries to access the slave 722, the guard 762 receives region ID “1” and compares it with the slave register information for region 1. For the RGID 1, a numeral “1” is provided for both read R and write W functionalities. Therefore the master 712 can perform both R&W on the slave 722.

Using the above system, any illegal access is blocked, and an error is flagged or reported to another part of the system. Accesses to Region ID configuration registers may also be protected by Region ID mechanism.

The system may be extended to many (more than 2) master components each one being associated with its own RGID.

To further improve the FFI mechanism, the system may also be provided with one or more additional verification circuits configured to compare the master identification with a list of permitted values. When identifying that the master identification is different from a permitted value the verification circuit changes the master identification to a predefined error value. When the protection circuit receives a master identification having the predefined error value, the protection circuit blocks access to a slave component. Alternatively, the verification circuit may directly prevent propagation of the master identification to the slave component.

The protection circuit may be implemented in different ways. For instance, the protection circuit may include one or more comparators. For instance the protection circuit may include two comparators. The first comparator compares the master identification with the list of permissible master identifications for performing a specific task on the slave component for example a read task. The second comparator compares the master identification with the list of permissible master identifications for performing another specific task on the slave component for example a write task. For each comparator a multiplexer may be provided to grant access only when the master identification matches a permissible master identification.

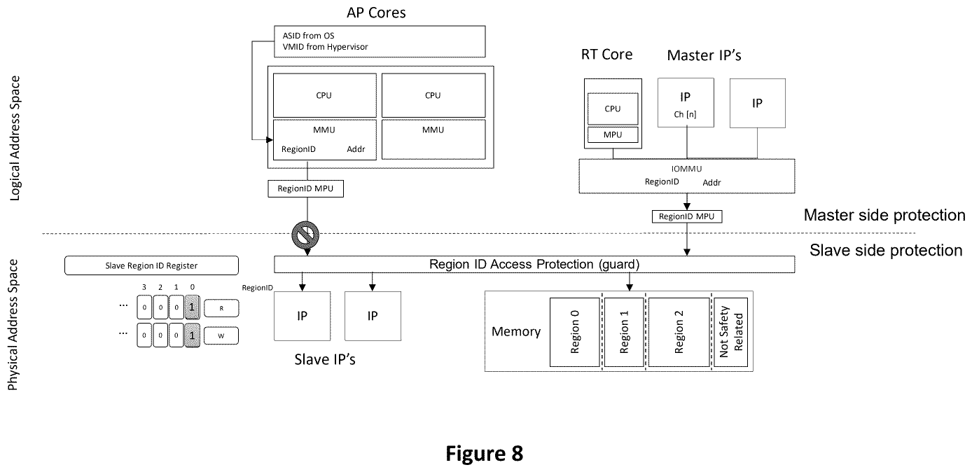

FIG. 8 is a diagram of a processing system provided with two verification circuits. The processing system includes two application (AP) cores, and one real-time (RT) core and two verification circuits referred to as RegionID MPUs or RGID MPUs, as they are used to protect the memory.

Each AP core has a CPU and an MMU. The RT core has a CPU, an MPU, an IOMMU and several hardware functionalities referred to as IP. Other IOMMU may be provided for other non-CPU masters within the SoC. In addition, several masters are provided with an additional Region ID MPU, also referred to as RGID MPU. In this example two RegionID MPUs are provided.

As explained above the master RGID may be configured by a dedicated register for each master. Alternatively, the RGID may be encoded in MMU/IOMMU stage 2 translation table entries. An MMU or IOMMU translation table includes a set of tables that map virtual addresses to physical addresses and provide access attributes. For instance, the region ID may be encoded in the upper x bits of the physical address, for instance the most significant bit (MSB) of the physical address.

The RegionID MPU is configured to check that the master RGID is within a pre-configured list. If the master RGID belongs to an allowable value, then the master RGID propagates to the guard. If not, the RegionID MPU blocks directly the propagation of the master RGID or alternatively change the master RGID to a pre-configured error value also referred to as false value “F”. When the master identification having the pre-configured error value is received by the guard, the guard prevents access to the slave component.

On the slave side, the slave register is configured for each slave. The nth bit represents whether master RGID n has access to this slave.

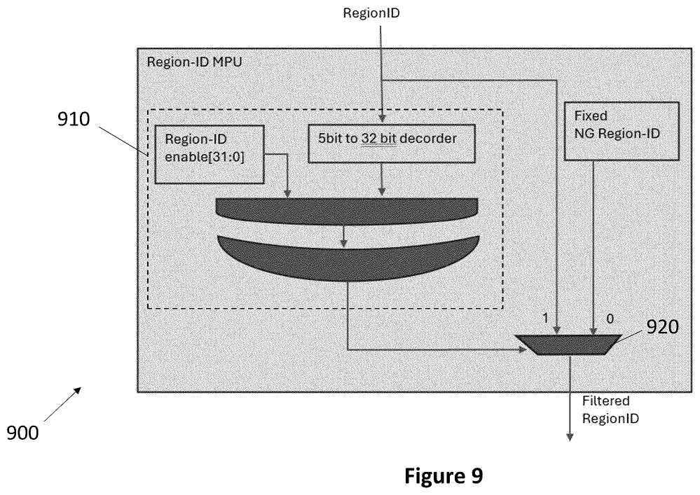

FIG. 9 is a diagram of an example implementation of a verification circuit or RegionID MPU. The RegionID MPU 900 includes a checking circuit 910 and a multiplexer 920, also referred to as data selector. The checking circuit 910 has a decoder for decoding the Region ID, a register storing a list of predefined accepted values RGID values and a comparator configured to compare the decoded RGID with the accepted or allowable RGID values. The multiplexer 910 has two inputs (channel 1 and channel 2) for receiving the RGID from the master, and a predefined region ID “F” to be blocked by the guard labelled a fixed NG region ID, respectively.

In operation the comparator outputs a selection signal that controls the output of the multiplexer 920. When the RGID is within the accepted list of RGID values, the selection signal selects channel 1 and the RGID is provided at the output of the multiplexer. When the RGID is outside of the accepted list of RGID values, the selection signal selects channel 2 and the NG RGID is provided at the output of the multiplexer.

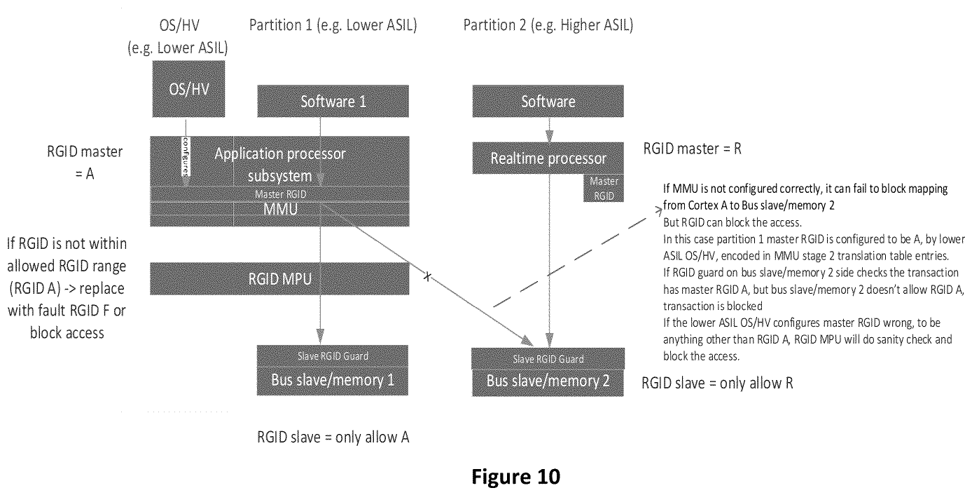

FIG. 10 is a diagram of a system having a lower ASIL partition (partition 1), a higher ASIL partition (partition 2) and a lower ASIL OS/HV. The lower ASIL partition and the lower ASIL OS/HV share a common MMU and a common RegionID MPU (RGID MPU). In partition 2, the master RGID is stored in a master register.

In operation, the lower ASIL OS/HV configures the master RGID of partition 1. The master RGID is encoded in MMU stage 2 translation table entries. The guard on the bus/slave memory 1 only allows access to the slave 1 when RGID master =A, otherwise the access is blocked. The guard on the bus/slave memory 2 only allows access to the slave 2 RGID master =R, otherwise the access is blocked.

If the MMU is not configured correctly, it can fail to block mapping from the application processor to the bus slave/memory 2. However, in this case the RegionID MPU is used to block access. If the lower ASIL OS/HV configures the master RGID in the wrong way, to be anything other than RGID A (for instance RGID R), then the RegionID MPU will perform a sanity check and block access.

The RegionID MPU checks the RGID master value. If the value is not within a permitted list (here value A), then it replaces the RGID value with a predefined value, for instance a fault RGID F, that will be blocked by the access guard also referred to as slave RGID guard. Alternatively, the RegionID MPU may block access directly by preventing further communication to the slave. The RegionID MPU is configured by the highest ASIL element, therefore it is assumed to be configured correctly. In the system of FIG. 10, the partition 2 configures the RegionID MPU. For instance, the realtime processor in partition 2 may configure the RegionID MPU in partition 1.

In this example the application processor subsystem does not have to use the highest ASIL OS or HV. This is because the RegionID MPU can be used to block access from the application processor subsystem with lower ASIL OS or HV to other higher ASIL areas.

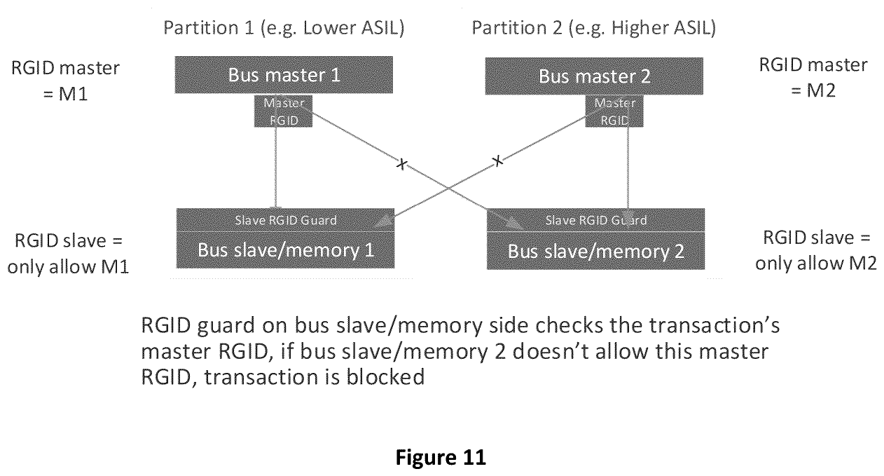

FIG. 11 is a diagram of another system partitioned between a lower ASIL domain and a higher ASIL domain. The master 1 stores master RGID=M1 on a master register. Similarly, the master 2 stores master RGID=M2 on a master register. Operation is similar to the operation of the system of FIG. 7. The masters 1 and 2 do not need to connect to the IOMMU. Instead, the RGID guard on bus/slave memory side checks the transaction's master RGID. If the RGID is not allowed the access to the bus slave/memory is blocked.

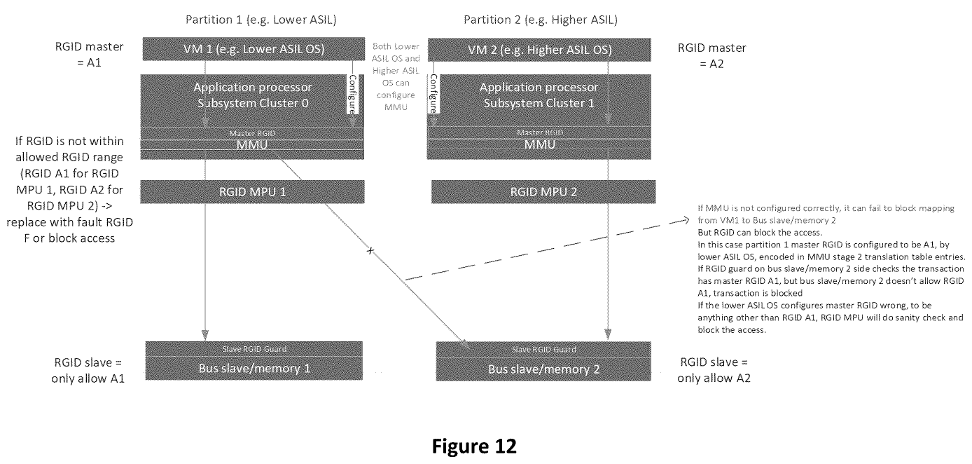

FIG. 12 is a diagram of a system having a lower ASIL partition (partition 1) and a higher ASIL partition (partition 2). The lower ASIL partition and the higher ASIL partition have separate MMUs and separate RegionID MPUs.

In this implementation the partition 1 master RGID is configured to be A1 by the lower AISL OS, and the partition 2 master RGID is configured to be A2 by the higher AISL OS. The master RGID may be encoded in MMU stage 2 translation table entries.

The guard on the bus/slave memory 1 only allows access to the slave 1 when RGID master=A1, otherwise the access is blocked. The guard on the bus/slave memory 2 only allows access to the slave 2 when RGID master=A2, otherwise the access is blocked.

If the MMU on partition 1 (lower ASIL) is not configured correctly, it can fail to block mapping from the application processor to the bus slave/memory 2. However, in this case the RegionID MPU 1 are used to block access. If the lower ASIL configures the master RGID in the wrong way, to be anything other than A1 (for instance RGID R), then the RegionID MPU 1 will perform a sanity check and block access.

The RGID MPU 1 checks the RGID master value. If the value is not within a permitted list (here value A1), then it replaces the RGID value with a predefined value, for instance a fault RGID F, that will be blocked by the guard. Alternatively, the RegionID MPU 1 may block access directly by preventing further communication to the slave.

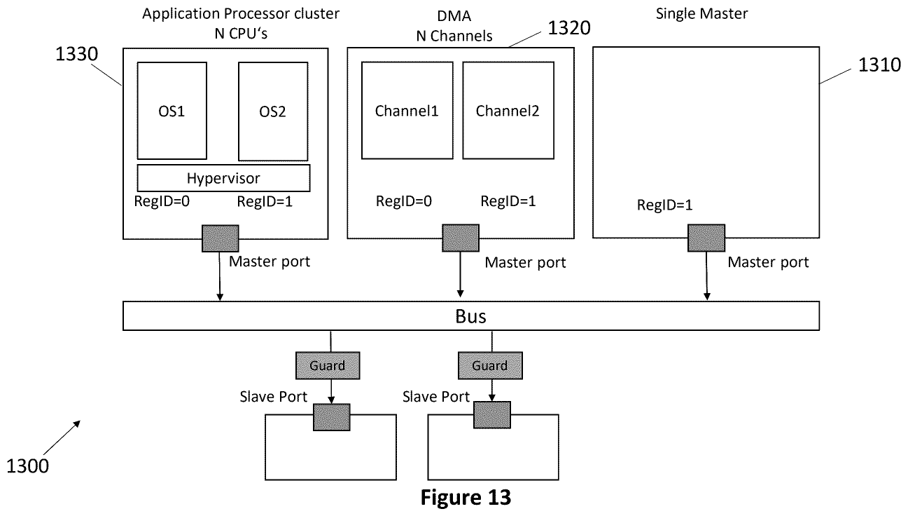

FIG. 13 is a diagram of a processing system comprising different types of master components. The processing system 1300 includes three master components. Each master is provided with a master port coupled to the bus.

The first master component 1310 referred to as single master is assigned a single master identification.

The second master component 1320, referred to as direct memory access (DMA), has a plurality N of channels of which only two are represented. A DMA channel is a component that manages memory access requests from one or more peripherals. In this case each channel is assigned a specific master identification.

The third master component 1330, referred to as application processor cluster, has a plurality N of CPUs, of which only two are represented. In this case each CPU is assigned a specific master identification. In this example each cluster contains separated CPUs having their own operating system (OS).

Therefore, depending on the implementation of the master component, the master component may be assigned more than one master identification. It will also be appreciated that depending on the application each domain in the partitioned system may not necessarily have different safety levels. For instance, each domain can be separated due to different software vendors or security requirements, to name a few.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A processing system comprising
a plurality of master components, wherein the processing system is configured to assign a master identification to each master component;
a plurality slave components;
a bus for communication between the plurality of master components and the plurality of slave components;
a plurality of slave registers, each slave register being configured to store a list of permissible master identifications that allow access to a corresponding slave component;
wherein each slave component has a protection circuit configured to permit or prevent access to the slave component based on the master identification of the master component attempting access.

2. The processing system as claimed in claim 1, wherein for each slave component the protection circuit is configured to compare a master identification with the list of permissible master identifications for the slave component, and to grant access only when the master identification matches a permissible master identification.

3. The processing system as claimed in claim 2, wherein access to a slave component is restricted to one or more specific task.

4. The processing system as claimed in claim 3, wherein the master identification comprises a number.

5. The processing system as claimed in claim 4, wherein each slave register is configured to store a binary sequence of zeros and ones for each task to be performed on the slave component and wherein each number (0 or 1) in the binary sequence is associated with a specific master identification.

6. The processing system as claimed in claim 1, comprising one or more master registers, each master register being configured to store a master identification for a corresponding master component.

7. The processing system as claimed in claim 1, wherein each master component comprises at least one of a master register, a memory management unit and an input-output memory management unit.

8. The processing system as claimed in claim 7, wherein each master register is configured to store a master identification for a corresponding master component.

9. The processing system as claimed in claim 7, wherein the memory management unit and the system memory management unit, each comprise a translation table, and wherein the master identification is encoded in the translation table.

10. The processing system as claimed in claim 8, comprising a configuration circuit adapted to configure the plurality of master registers and slave registers.

11. The processing system as claimed in claim 9, wherein the translation table is configured by an operating system or by a user software.

12. The processing system as claimed in claim 1, further comprising a verification circuit configured to compare the master identification with a list of permitted values; and wherein when identifying that the master identification is different from a permitted value the verification circuit if configured to change the master identification to a predefined error value or to block propagation of the master identification.

13. The processing system as claimed in claim 12, wherein when the protection circuit receives a master identification having the predefined error value, the protection circuit is configured to block access to a slave component.

14. The processing system as claimed in claim 1, wherein the processing system is spatially partitioned in a plurality of domains, wherein for each domain at least one master component and at least one slave component are assigned to a specific application or function.

15. The processing system as claimed in claim 14, wherein master components serving one application or function cannot access the slave components serving another application or function.

16. The processing system as claimed in claim 14, wherein each domain has a different characteristic.

17. The processing system as claimed in claim 1, wherein at least one master component comprises a plurality of sub parts, and wherein the processing system is configured to assign a master identification to each sub part of the master component.

18. The processing system as claimed in claim 1, wherein the processing system is implemented as an integrated electronic system.

19. A method of preventing interference in a processing system comprising a plurality of master components and a plurality of slave components, the method comprising
assigning a master identification to a corresponding master component;
storing a list of permissible master identifications that allow access to a corresponding slave component;
permitting or preventing a master component to access a slave component based on the master identification of the master component.

20. The method as claimed in claim 19, wherein the step of permitting or preventing access to a slave component comprises comparing a master identification with a list of permissible master identifications for the slave component, and only permitting access when identifying a match between a master identification and a permissible master identification.
